(19) United States
(12) Patent Application Publication
(10) Pub. No.: US 2010/0055224 A1
(43) Pub. Date: Mar. 4, 2010

(54) Suction Structure for a Mold

(75) Inventors: Chun-Yen Hung, Hsichih (TW); Chen-Feng Hsieh, Hsichih (TW)

Correspondence Address: KILE GOEKJIAN REED & MCMANUS, 1200 NEW HAMPSHIRE AVE, NW, SUITE 570, WASHINGTON, DC, 20036, US

(73) Assignee: WISTRON CORP.

(21) Appl. No.: 12/266,213

(22) Filed: Nov. 6, 2008

(30) Foreign Application Priority Data
Sep. 3, 2008 (TW) 97133689

(51) Int. Cl. B29C 51/36

(52) U.S. Cl. 425/405.1

(57) ABSTRACT

A suction structure for a mold includes a mold base, two airtight units, a plurality of air holes, and a plurality of air channels. The two airtight units are disposed in the mold base at interval and a suction zone is defined between the two airtight units. The plurality of air holes is located in the suction zone. The plurality of air channels is located in the suction zone and connected with the plurality of air holes. Based on the engagement of the suction zone, the plurality of air holes, and the plurality of air channels, a thin film can adhere to a mold via vacuum as air within the suction zone is extracted through the plurality of air holes. Thus, the thin film adheres to the mold fast and in a level manner, and thereby improving the yield rate of In-Mold Decoration process.

### BACKGROUND OF THE INVENTION

1. Field of the Invention

The present invention relates to a suction structure, and more particularly to a suction structure for a mold which is applied to in-mold transfer printing technology.

2. Description of Related Art

With the development of a new generation of electronic consumer products, the design of an electronic product's appearance is quite important so as to differentiate the new generation from the older models. Therein, shell design of the electronic product is a crucial factor regarding product appearance design, which not only influences consumers' first impressions, but also may lead to changes to the shell such as product construction materials (for example some consideration may includes a desire of reduction to harmful substances, lightness, or product endurance), manufacturing method, post-processing (for simplifying process). In order to achieve visual and textile variation for 3C (Computer, Consumer, Communication) products, surface treatment technology has progressed steadily over the years, for example, In-Mold Decoration (IMD), Vacuum Sputter, Anodic Treatment, and so on are surface treatment technologies usually used in 3C product shell manufacturing in recent years. Therein, since the IMD process has the advantages of reduced manufacturing process step, high yield rate, rich color variation possibilities, and pattern printing capability, the IMD process has recently became the primary process of main surface treatment technology for notebook computer shells.

The most important step in the In-Mold Decoration process is to adhere a transfer thin film to a female mold via vacuum, wherein the transfer thin film transfers desired pattern to the female mold so as to enhance product appearance. If the adherence/suction efficiency via vacuum is low, the In-Mold Decoration process failure rate would increase, which leads to a decrease of product yield rate. Please refer to FIG. 1 illustrating a suction structure for a female mold base used in a conventional In-Mold Decoration process. The suction structure includes a female mold base 1a, an airtight ring 2a, and four air holes 3a. The airtight ring 2a is disposed around the female mold base 1a and further forms an adherence zone 21a. The four air holes 3a are located in the adherence zone 21a near the center of the female mold base 1a and furthermore the four air holes 3a extend through the female mold base 1a. In order to achieve adherence of a transfer thin film via vacuum, air in the adherence zone 21a is removed through the four air holes 3a so that the transfer thin film sticks to the female mold.

However, the suction structure for a female mold base used in conventional In-Mold Decoration process has the shortcomings as follows:

1. The airtight ring 2a is located on the outermost edge of the work piece (i.e. female mold base 1a) and there is only one airtight ring 2a for coverage, so the resulting airtight range is large and requires a long time to for air to be removed so that the transfer thin film can be completely attached to the female mold, thereby affecting production capacity and energy consumption.

2. The air holes 3a are near the center of the female mold base 1a, so when the adherence zone 21 is large due to conventional airtight ring 2a design, the time for removing air increases; at the same time, when the vacuum/suction efficiency is low, the corners of the transfer thin film are easily crumpled, which affects the subsequent working procedure of forming the actual product by the mold, thereby leading to defected product with crumpled surfaces, so the yield rate is reduced.

Hence, the inventors of the present invention believe that the aforementioned shortcomings are improvable and finally suggest the present invention which is of a reasonable design and is an effective improvement based on extensive research and thought.

### SUMMARY OF THE INVENTION

An object of the present invention is to provide a suction structure for a mold which is applied in an In-Mold Decoration (IMD) process. Based on the structural design of the present invention, the suction structure for a mold can make a suction range of a mold be concentrated on the suction portion so as to reduce the suction area, thereby avoiding energy waste and reducing production costs.

Another object of the present invention is to provide a suction structure for a mold which can reduce the time in which a thin film adheres to a mold via vacuum so as to improve production efficiency.

Another object of the present invention is to provide a suction structure for a mold which is applied in an In-Mold Decoration (IMD) process and ensures that a thin film can adhere to a mold faster and more exact (i.e. precise), and the adhered thin film does not crumple easily due to the increased precision of adherence.

To achieve the aforementioned objects, a suction structure for a mold in accordance with the present invention is provided. The suction structure for a mold which is used in an In-Mold Decoration (IMD) process, includes: a mold base; at least two airtight units which are disposed in the mold base in an inside and outside arrangement mode, a suction zone defined between the two airtight units; and a plurality of air holes which extends through the mold base and is located in the suction zone, wherein air inside the suction zone can be extracted from the suction zone through the plurality of air holes so as to generate a vacuum condition for the adherence of a subject (such as the thin film) to the mold base.

In other words, the two airtight units form the inner range and outer range for the suction zone, and this formation is referred to as the inside and outside arrangement mode. The two airtight units working in conjunction with the plurality of air holes which exists within the suction zone, enables the creation of a vacuum condition that is used to adhere the thin film to the mold.

The present invention further provides a suction structure for a mold which is used in an In-Mold Decoration (IMD) process. The suction structure for a mold includes: a mold base; at least two airtight units which are disposed in the mold base in an inside and outside arrangement mode, a suction zone defined between the two airtight units; a plurality of air holes which extends through the mold base and is located in the suction zone, wherein air inside the suction zone can be extracted from the suction zone through the plurality of air holes so as to generate a vacuum condition for the adherence of a subject (such as the thin film) to the mold base; and a plurality of air channels which is carved in the mold base and located in the suction zone, the plurality of air channels are connected with the plurality of air holes for accelerated and uniform suction of air within the suction zone.

Consequently, the suction structure for a mold of the present invention has the efficacy as follows:

Based on the arrangement of the air holes, the air channels and the engagement of the airtight units in an inside and outside arrangement mode, the present invention can reduce the suction area from covering the whole of the mold base, to a minimized suction zone of within the suction zone, which is made possible by the airtight units with an inside and outside arrangement mode, thereby improve the vacuum suction efficiency; furthermore, due to the minimized suction zone, the force of adherence generated by the vacuum is better concentrated around the thin film, and because less air are within the minimized suction zone, thereby the suction time is reduced; additionally, the arrangement of the air channels ensures that the thin film adheres to the mold base smoothly (i.e. in a level manner), more specifically, the suction zone of the present invention is concentrated on the zone that requires the extraction of air as suppose to blindly generating vacuum on the overall mold base, so the thin film can adhere to the mold base fast, thereby the vacuum suction time is reduced, the production capacity is raised, and the energy consumption is reduced.

To further understand the techniques, methods, and efficacy of the present invention, please refer to the following detailed description and drawings related the present invention, and it is believed that the objects, characteristics, and features of the present invention can be further understood. However, the drawings are only to be used as references and explanations, not to limit the present invention.

### BRIEF DESCRIPTION OF THE DRAWINGS

FIG. 1 is a structural schematic view of a conventional suction structure for female mold bases;

FIG. 2A is a structural schematic view of a suction structure for a mold of the present invention;

FIG. 2B is another structural schematic view of the suction structure for a mold of the present invention;

FIG. 2C is another structural schematic view of the suction structure for a mold of the present invention;

FIG. 3A is a structural schematic view of a suction structure of a second embodiment of the present invention;

FIG. 3B is another structural schematic view of the suction structure of the second embodiment of the present invention; and

FIG. 3C is another structural schematic view of the suction structure of the second embodiment of the present invention.

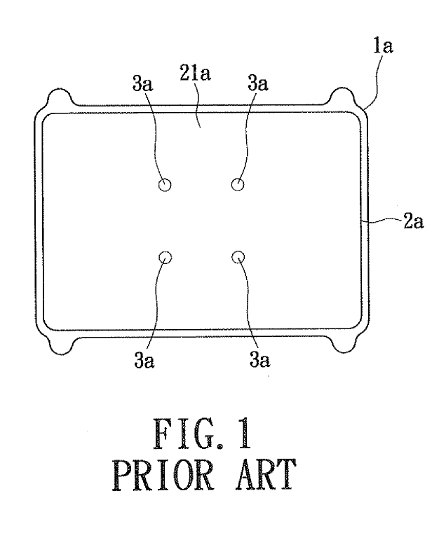

### DETAILED DESCRIPTION OF PREFERRED EMBODIMENTS

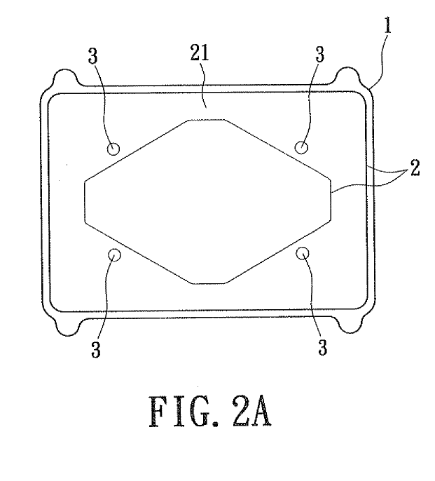

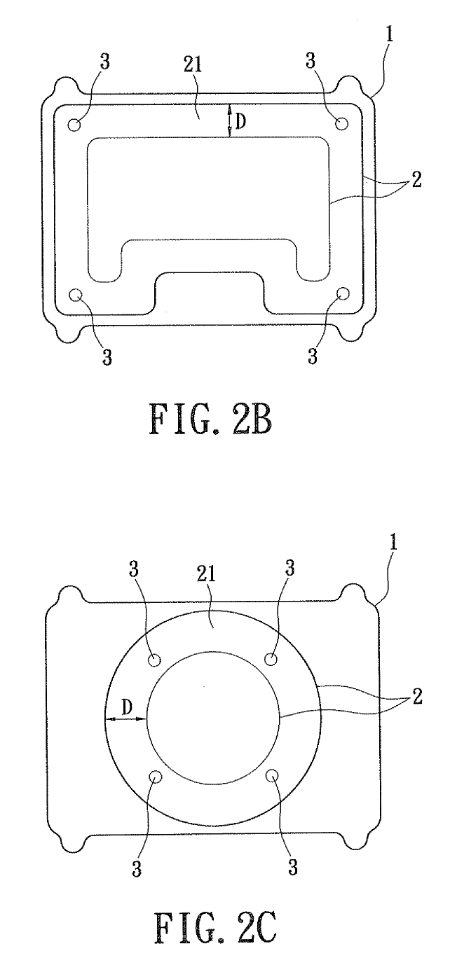

Please refer to FIG. 2A, a suction structure for a mold in accordance with a preferred embodiment of the present invention is applied in an In-Mold Decoration (IMD) process. The suction structure for a mold includes a mold base 1, at least two airtight units 2 and a plurality of air holes 3. The mold base 1 is installed in an injection molding machine station (not shown), and the two airtight units 2 and the plurality of air holes 3 are all located in the mold base 1.

The two airtight units 2 are disposed in the mold base 1 in an inside and outside arrangement mode, wherein the inside and outside arrangement mode of the two airtight units 2 defines the suction zone 21. The two airtight units 2 are respectively in closed shape, the closed shape of one airtight unit 2 defines the inner range of the suction zone 21, the close shape of the other airtight unit 2 defines the outer range of the suction zone 21. In other words, the suction zone 21 is defined between the two airtight units 2. The shapes of the two airtight units 2 are determined according to the shape of a subject waiting to be processed (not shown), so the shape of the two airtight units 2 may vary, which may include round shapes, square shapes, symmetric geometric shapes, or any other shapes (as shown in FIG. 2B and FIG. 2C). Accordingly, since the two airtight units 2 may be in any shape, the suction zone 21 formed between the two airtight units 2 may be in any shape (as shown in FIG. 2B and FIG. 2C).

The suction zone 21 is a vacuum suction zone which is disposed along a periphery of the subject (i.e. the thin film that is to be transferred) waiting to be processed (not shown) according to the shape of the subject waiting to be processed (not shown). Based on the arrangement of the suction zone 21, the suction area of the suction zone 21, which has been minimized by the inside and outside arrangement mode, leads to a decrease of time for a thin film to be attached to a mold (not shown), since the minimized suction zone 21 has less air that requires extraction. Additionally, what is needed to be mentioned is that the size of the suction zone 21 may be adjusted according to operator or application demands. The suction area of the suction zone 21 is increased or decreased via adjusting the relative distance between the inside and the outside airtight units 2 (as shown in FIG. 2B and FIG. 2C) thereby affecting the time required for the adherence of the thin film to the mold. In other words, when the airtight unit 2 that defines the outer range of the suction zone 21 is fixed, the relative distance D (as shown in FIGS. 2B and 2C) that is between the two airtight units 2 may be adjusted so as to increase or decrease the suction area.

Specifically speaking, the airtight units 2 may be common airtight rings for providing a regional blocking effect, or may be any component which has an airtight effect for avoiding air leakage. Furthermore, the materials of the two airtight units 2 may be plastic materials or rubber materials for a better airtight effect.

The plurality of air holes 3 extends through the mold base 1. The plurality of air holes 3 is evenly distributed in the suction zone 21 according to the shape of the subject (i.e. the thin film that is to adhere to the mold base 1) waiting to be processed (not shown), wherein one end of each air hole 3 is connected to a suction source (such as a vacuum pump or other machinery that may extract air, not shown) and the other end thereof is located in the suction zone 21 thereby air can be extracted from the suction zone 21 through the plurality of air holes 3. Additionally, the number of the air holes 3 isn't limited and may be increased or decreased depending on operator or application demands, and in the present embodiment, the number of the air holes 3 is four.

Furthermore, for the adherence of the thin film (not shown) to occur in a level manner (i.e. smoothly), the plurality of air holes 3 may be further evenly distributed corresponding to the four corners of the subject waiting to be processed (not shown), that is, the plurality of air holes 3 may be formed in the corners of the suction zone 21. Because the corners of the suction zone 21 (not shown) are the easily area to be crumpled when the thin film (not shown) adheres to the mold base 1, which means that the suction efficiency in the corners of the suction zone 21 is the low compare to the rest of the suction zone 21, so to arrange the plurality of air holes 3 at the corners of the suction zone 21 improves the suction efficiency, and thereby the thin film (not shown) can adhere to the mold (not shown) faster and isn't easy to be crumpled.

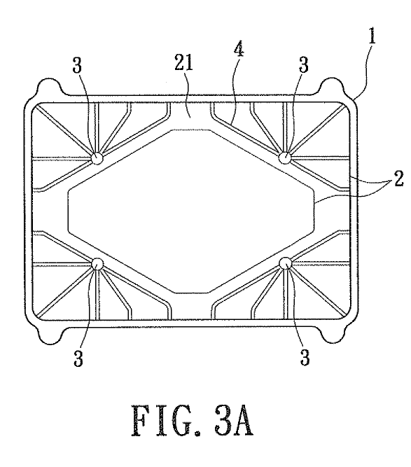

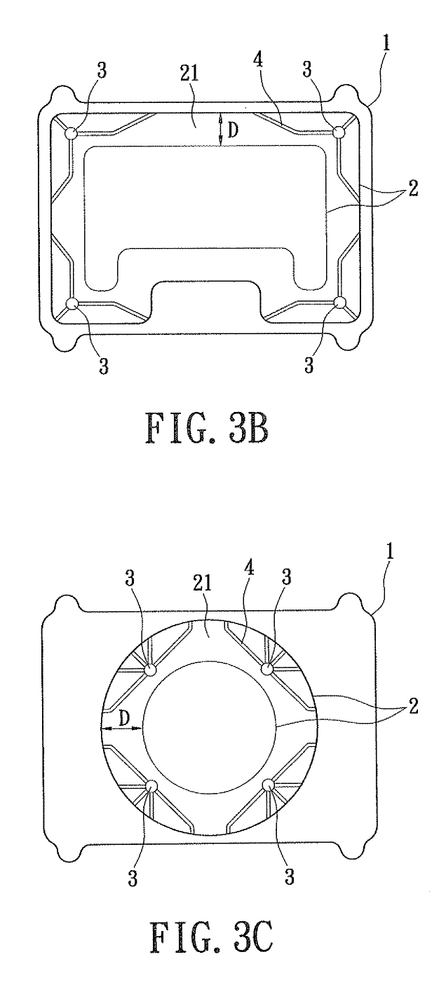

Please refer to FIG. 3A illustrating a second embodiment of the suction structure for a mold of the present invention. The difference between the second embodiment and the previous embodiment is the arrangement of air channels 4. In the second embodiment, the suction structure for a mold includes a mold base 1, at least two airtight units 2, a plurality of air holes 3, and a plurality of air channels 4. The mold base 1 is installed in an injection molding machine station (not shown), and the two airtight units 2, the plurality of air holes 3, and the plurality of air channels 4 are all located in the mold base 1.

Since the structures and the relationships of the mold base 1, the airtight units 2, the air holes 3, and the suction zone 21 of the second embodiment are the same as those of the previous embodiment, the detailed description is omitted.

The plurality of air channels 4 is carved in the mold base 1 and evenly distributed in the suction zone 21. The plurality of air channels 4 is respectively connected with the plurality of air holes 3 and radially extends from the plurality of air holes 3 in the suction zone 21. Based on the arrangement of the plurality of air channels 4, the suction effect is improved, and the thin film (not shown) can adhere to the mold (not shown) in a more level manner (i.e. more smoothly) and faster, thereby decreasing the suction time, speeding up the In-Mold Decoration (IMD) process and raising production capacity. Additionally, the number of the air channels 4 isn't limited and may be increased or decreased depending on operator and application demands.

It is further mentioned that in the present embodiment, the size of the suction zone 21 may be discretionarily adjusted (as shown in FIG. 3B and FIG. 3C) so that the suction area of the suction zone 21 can be increased or decreased according to operator and application demands. Since the structure and the relationship is the same as that of the previous embodiment, the detailed description is omitted.

Consequently, the suction structure for a mold of the present invention has the characteristics as follows:

1. Based on the structural improvement, the present invention can reduce the suction area by establishing a suction zone that is minimized in size by two airtight units, so as to improve the vacuum suction efficiency, and reduce the suction time, and thereby increase yield.

2. The airtight units of the present invention separate the area of the mold base that does not require adherence of thin film, so the suction area is reduced so that the suction time is reduced.

3. Based on the arrangement of the plurality of air channels of the present invention, the suction effect is improved, that is, the suction time is reduced and the thin film (not shown) can adhere to the mold (not shown) more smoothly, in a more level manner. This is due to the reduced suction area formed by the suction zone, so that the same amount vacuum force is now concentrated to a focused area.

4. Based on the present invention, the periphery of the thin film can adhere to the mold faster and more precisely and the adhered thin film does not crumple easily to the reduced size of thin film covering the mold base and the concentrated vacuum force.

5. The suction zone of the present invention is concentrated on the zone that needs air to be extracted, so the thin film can adhere to the mold base fast, thereby the vacuum suction time is reduced, the production capacity is raised and the energy consumption is reduced.

What are disclosed supra are only the specification and the drawings of the preferred embodiments of the present invention. It will be understood by those skilled in the art that various equivalent changes may be made depending on the specification and the drawings of the present invention without departing from the scope of the present invention.

What is claimed is:

1. A suction structure for a mold which is used in an In-Mold Decoration (IMD) process, comprising:
a mold base;
at least two airtight units, disposed in the mold base in an inside and outside arrangement mode, a suction zone defined between the two airtight units; and
a plurality of air holes, extending through the mold base and located in the suction zone, wherein air inside the suction zone can be extracted from the suction zone through the plurality of air holes so as to generate a vacuum condition for the adherence of a subject to the mold base.

2. The suction structure for a mold as claimed in claim 1, wherein the plurality of air holes corresponds to four corners of the subject.

3. The suction structure for a mold as claimed in claim 1, wherein the shapes of the two airtight units are determined according to the shape of the subject.

4. The suction structure for a mold as claimed in claim 1, wherein the suction zone is disposed along a periphery of the subject, and the shape of the suction zone corresponds to that of the subject.

5. The suction structure for a mold as claimed in claim 1, wherein the airtight units are airtight rings.

6. The suction structure for a mold as claimed in claim 1, wherein the materials of the airtight units are plastic materials or rubber materials.

7. A suction structure for a mold which is used in an In-Mold Decoration (IMD) process, comprising:
a mold base;
at least two airtight units, disposed in the mold base in an inside and outside arrangement mode, a suction zone defined between the two airtight units;
a plurality of air holes, extending through the mold base and located in the suction zone, wherein air inside the suction zone can be extracted from the suction zone through the plurality of air holes so as to generate a vacuum condition for the adherence of a subject to the mold base; and
a plurality of air channels, carved in the mold base and located in the suction zone, the plurality of air channels are connected with the plurality of air holes for accelerated and uniform suction of air within the suction zone.

8. The suction structure for a mold as claimed in claim 7, wherein the plurality of air holes corresponds to four corners of the subject.

9. The suction structure for a mold as claimed in claim 8, wherein the plurality of air channels radially extends from the plurality of air holes.

10. The suction structure for a mold as claimed in claim 7, wherein the plurality of air channels is evenly distributed in the suction zone.

11. The suction structure for a mold as claimed in claim 7, wherein the shapes of the two airtight units are determined according to a shape of the subject.

12. The suction structure for a mold as claimed in claim 7, wherein the suction zone is disposed along a periphery of the subject, and the shape of the suction zone corresponds to that of the subject.

13. The suction structure for a mold as claimed in claim 7, wherein the airtight units are airtight rings.

14. The suction structure for a mold as claimed in claim 7, wherein the materials of the airtight units are plastic materials or rubber materials.
